(19) United States
(12) Patent Application Publication
(10) Pub. No.: US 2026/0117839 A1
(43) Pub. Date: Apr. 30, 2026

(54) VALVED BUMP STOP

(71) Applicant: Fox Factory, Inc., Duluth, GA (US)

(72) Inventors: Dustin Munts, Gainesville, GA (US); Matthew Stewart, Buford, GA (US)

(21) Appl. No.: 18/931,441

(22) Filed: Oct. 30, 2024

(51) Int. Cl. F16F 9/58; B60G 17/08; F16K 15/02

(52) U.S. Cl. CPC F16F 9/585; B60G 17/08; F16K 15/025; B60G 2204/45; F16F 2230/007; F16K 2200/402

(57) ABSTRACT

A valved bump stop is provided that includes a damper body, a piston rod extending into the damper body with a valve coupled to the piston rod within the damper body and a bumper coupled to an end of the piston rod extending out of the damper body. The valve includes a piston having an inner volume, an inlet, and spool apertures through a sidewall of the piston into the inner volume. The valve also includes a spool having a fluid engagement surface, a spring engagement surface, and a control orifice. The spool may be coupled within the inner volume of the piston. The spring engages the spring engagement surface and biases the spool to a closed position covering the spool apertures. The spool moves to an opened position exposing the spool apertures in response to fluid pressure applied to the fluid engagement surface exceeding the spring's spring rate.

### BACKGROUND OF THE INVENTION

### Technical Field

This invention relates generally to a hydraulic bump stop and more particularly to a valved hydraulic bump stop.

### State of the Art

Vehicles suspension always have a possibility to bottom out. In order to avoid such a situation, vehicles may employ a bump stop, also referred to as a jounce bumper, or a jounce bouncer. The term “jounce” refers to the shock traveling towards full compression or bottoming out. When the suspension is fully compressed (bottoms out), damage can result to the suspension, the frame of the vehicle or both. In addition, bottoming out has other negative effects, such as vehicle control issues and discomfort for vehicle passengers. Bump stops operate to prevent bottoming out to protect the suspension and vehicle, while avoiding the other issues presented when a vehicle bottoms out.

Conventional orifice controlled hydraulic bump stops are a low cost and dead length efficient solution but have an inherent progressive damping curve. The term “dead length” is the length of the bump stop that does not contribute to active damper travel. At high rod speeds, damping force may be much higher than desired to meet mid-speed damping targets.

Accordingly, there is a need for a valved bump stop that provides the benefits of an orifice controlled hydraulic bump stop while reducing damping force at higher rod speeds.

### SUMMARY OF THE INVENTION

An embodiment includes a valve for a bump stop, the valve comprising: a piston comprising an inner volume, an inlet for fluid flow to enter the inner volume, and a plurality of spool apertures extending through a sidewall of the piston into the inner volume; a spool comprising a first end, a second end, a fluid engagement surface facing the first end, a spring engagement surface facing the second end, and a control orifice providing fluid access from the first end to the second end, the spool coupled within the inner volume with the first end positioned toward the inlet of the piston, the spool moveable between a closed position and an opened position; and a spring engaging the spring engagement surface of the spool, wherein: the spring biases the spool to the closed position covering the plurality of spool apertures preventing fluid flow therethrough and only allowing fluid flow through the control orifice; and the spool moves to the opened position by compressing the spring in response to fluid pressure applied to the fluid engagement surface of the spool exceeds a spring rate of the spring, wherein the opened position exposed at least a portion of each of the plurality of spool apertures allowing fluid flow through the plurality of spool apertures and the control orifice.

Another embodiment includes a valved bump stop comprising: a damper body; a piston rod partially extending into the damper body; a bumper coupled to an end of the piston rod that extends out of the damper body; and a valve coupled to an end of the piston rod that extends into the damper body, wherein the valve comprises: a piston comprising an inner volume, an inlet for fluid flow to enter the inner volume, and a plurality of spool apertures extending through a sidewall of the piston into the inner volume; a spool comprising a first end, a second end, a fluid engagement surface facing the first end, a spring engagement surface facing the second end, and a control orifice providing fluid access from the first end to the second end, the spool coupled within the inner volume with the first end positioned toward the inlet of the piston, the spool moveable between a closed position and an opened position; and a spring engaging the spring engagement surface of the spool, wherein: the spring biases the spool to the closed position covering the plurality of spool apertures preventing fluid flow therethrough and only allowing fluid flow through the control orifice; and the spool moves to the opened position by compressing the spring in response to fluid pressure applied to the fluid engagement surface of the spool exceeds a spring rate of the spring, wherein the opened position exposed at least a portion of each of the plurality of spool apertures allowing fluid flow through the plurality of spool apertures and the control orifice.

Another embodiment includes a method of using a valved bump stop, the method comprising: coupling a valved bump stop to a vehicle, the valved bump stop comprising: a damper body; a piston rod partially extending into the damper body; a bumper coupled to an end of the piston rod that extends out of the damper body; and a valve coupled to an end of the piston rod that extends into the damper body; contacting the bumper with a control arm of a vehicle during a high-speed compression cycle of a suspension of the vehicle; moving, at a high speed, the piston rod and the valve further into the damper body in response to the control arm contacting the bumper; initiating fluid flow into the valve and through a control orifice of the valve in response to moving the valve into the damper body; moving the valve from a closed position to an opened position in response to fluid pressure exceeding a predetermined level; opening additional fluid flow area in response to the valve moving to the opened position; and flowing fluid through the control orifice of the valve and the additional fluid flow area.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is an exploded view of a valve of a valved bump stop, according to an embodiment;

FIG. 2 is a perspective view of a piston of a valve of a valved bump stop, according to an embodiment;

FIG. 3 is a side view of a piston of a valve of a valved bump stop, according to an embodiment;

FIG. 4A is a perspective view of a spool of a valve of a valved bump stop, according to an embodiment;

FIG. 4B is a section view of a spool of a valve of a valved bump stop, according to an embodiment;

FIG. 5 is a section view of a valved bump stop, according to an embodiment;

FIG. 6 is a section view of a valve of a valved bump stop with the valve in a closed position, according to an embodiment;

FIG. 7 is a section view of a valve of a valved bump stop with the valve in a partially opened position, according to an embodiment;

FIG. 8 is a section view of a valve of a valved bump stop with the valve in an opened position, according to an embodiment;

FIG. 9 is a section view of another embodiment of a valve of a valved bump stop with the valve in an opened position, according to an embodiment;

FIG. 10 is a section view of another embodiment of a valve of a valved bump stop with the valve in an opened position, according to an embodiment;

FIG. 11 is a section view of another embodiment of a valve of a valved bump stop with the valve in an opened position, according to an embodiment; and

FIG. 12 is a section view of another embodiment of a valve of a valved bump stop with the valve in an opened position, according to an embodiment.

### DETAILED DESCRIPTION OF EMBODIMENTS OF THE INVENTION

As discussed above, embodiments of the present invention relate to valved bump stop that provides the benefits of an orifice controlled hydraulic bump stop while reducing damping force at higher rod speeds. A valve in accordance with embodiments of the valved bump stop open up additional flow area once a predetermined pressure target is reached thereby reducing damping force at higher rod speeds. This effectively acts as a variable pressure blow off.

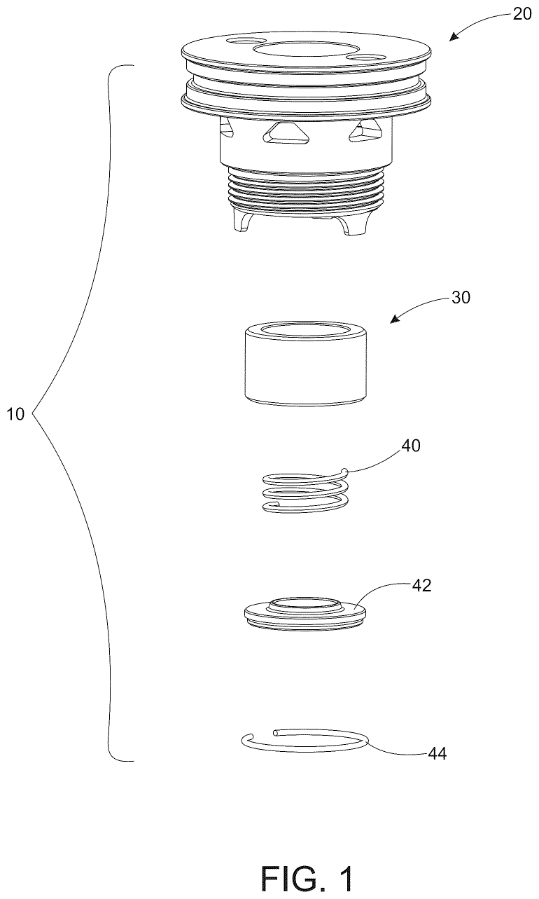

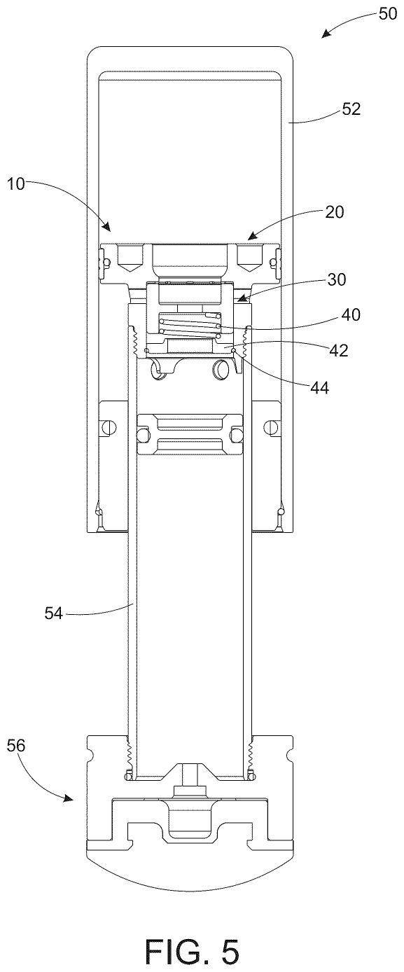

Referring to the drawings, FIGS. 1-8 depicts an embodiment of a valved bump stop 50 that comprises an embodiment of a valve 10 used within a valved bump stop 50. Referring specifically to FIGS. 1 and 5, the valved bump stop 50 generally comprises a damper body 52, a piston rod 54 with a valve 10 coupled to an end of the piston rod 54 that extends into the damper body 52, and a bumper 56 coupled to an end of the piston rod 54 that extends out of the damper body 52. The valve 10 generally comprises a piston 20, a spool 30, a spring 40, a spring seat 42 and a lock washer 44.

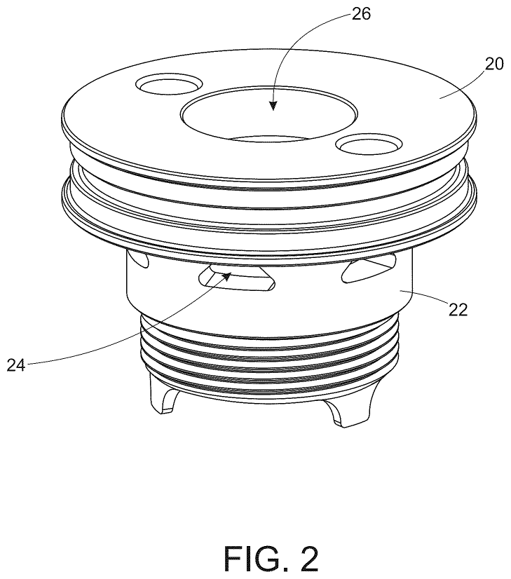

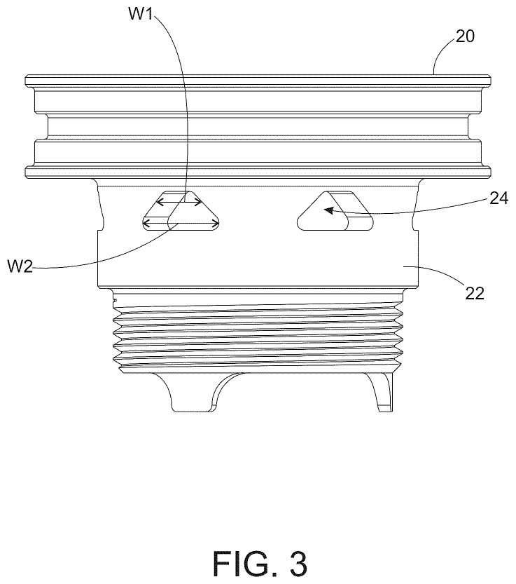

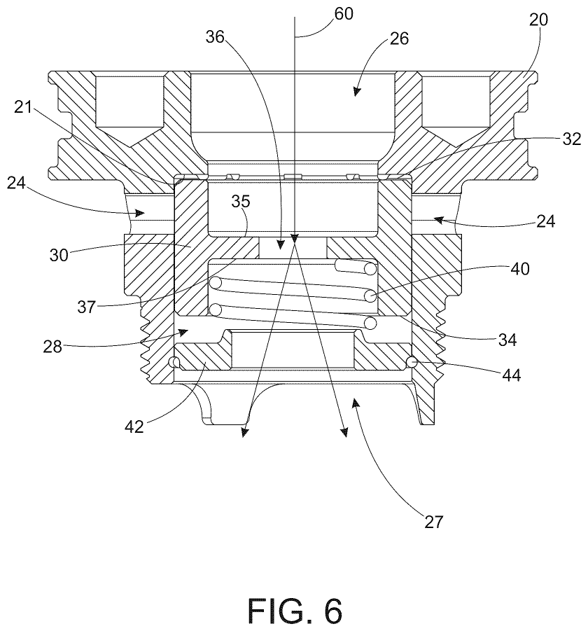

Referring to FIGS. 2-3, the piston 20 comprises a side wall 22, one or more spool apertures 24, an inlet 26, an outlet 27, and an inner volume 28 (see FIG. 6). The spool apertures 24 extend through the side wall 22 and into the inner volume 28 to allow fluid flow from the inlet 26 through the spool apertures 24. Each spool aperture 24 comprises a variable width. As shown in FIG. 3, a width W1 of the spool aperture 24 is less than a width W2 of the spool aperture 24. The width of the spool aperture 24 becomes greater as the spool aperture 24 extends from an end of the piston 20 closer to the inlet 26 to the end of the piston 20 closer to the outlet 27.

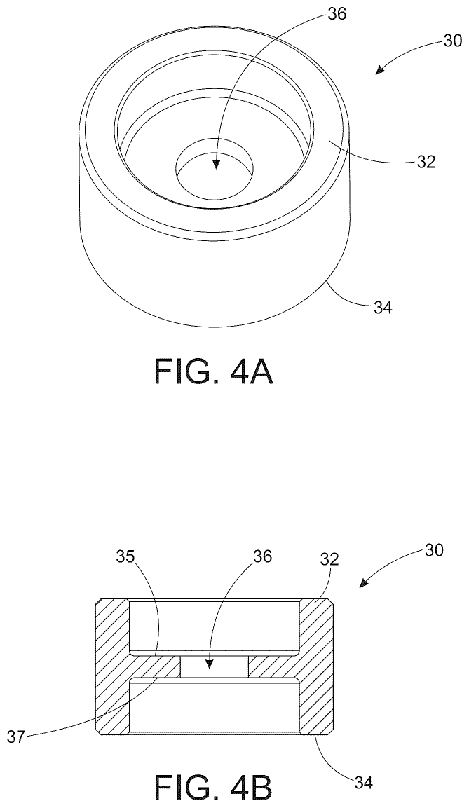

Referring to FIGS. 4A-4B, the spool 30 comprises a first end 32, a second end 34, and a control orifice 36 providing fluid access from the first end 32 to the second end 34. The spool 30 comprises a fluid engagement surface 35 located on the same side of the spool 30 as the first end 32. The spool 30 comprises a spring engagement surface 37 located on the same side of the spool 30 as the second end 34. In embodiments as depicted in FIGS. 4A-4B, the fluid engagement surface 35 and spring engagement surface 37 are recessed from the first end 32 and the second end 34 respectively. Further, the control orifice 36 extends through the fluid engagement surface 35 and spring engagement surface 37.

Referring to FIGS. 1 and 6-8, embodiments of the valve 10 are depicted. The piston 20 is configured to receive the spool 30 within the inner volume 28. The spool 30 is positioned within the piston 20 with the fluid engagement surface 35 facing the input 26 of the piston 20 and the spring engagement surface 37 facing the output 27. The spring 40 engages the spring engagement surface 37 on one end of the spring 40 and engages a spring seat 42 on the other end of the spring 40. The spring seat 42 is retained within the inner volume 28 of the piston 20 by use of a lock washer 44. The spring seat 42 also provides preload to the spring 40 based on the distance the spring seat 42 is from the spring engagement surface 35 of the spool 30. This preload of the spring 30 biases the spool 30 to a closed position. In the closed position, the first end 32 of the spool 30 engages a lip 21 of the piston 20 and covers the spool apertures 24, thereby preventing fluid flow through the spool apertures 24. The spool 30 is moveable within the inner volume 28 of the piston 20 when a force acts upon the fluid engagement surface 35 that exceeds a spring rate of the spring 40 to move the spool 30 into the opened position. The opened position exposes at least a portion of each of the spool apertures 24 to allow fluid flow through the spool apertures 24.

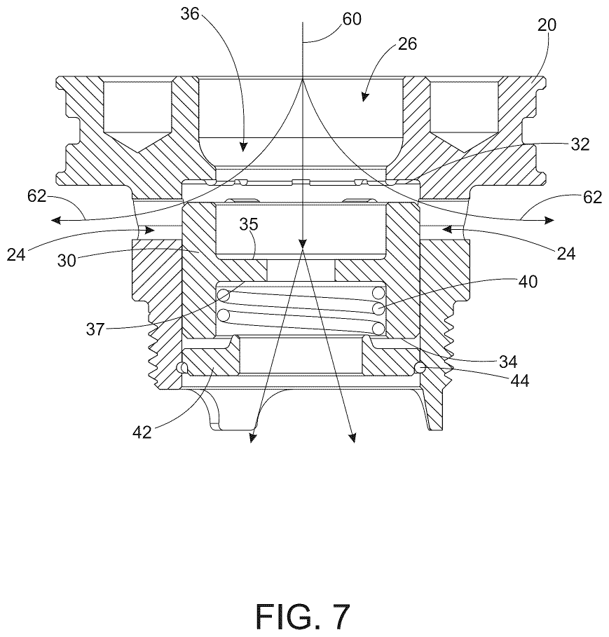

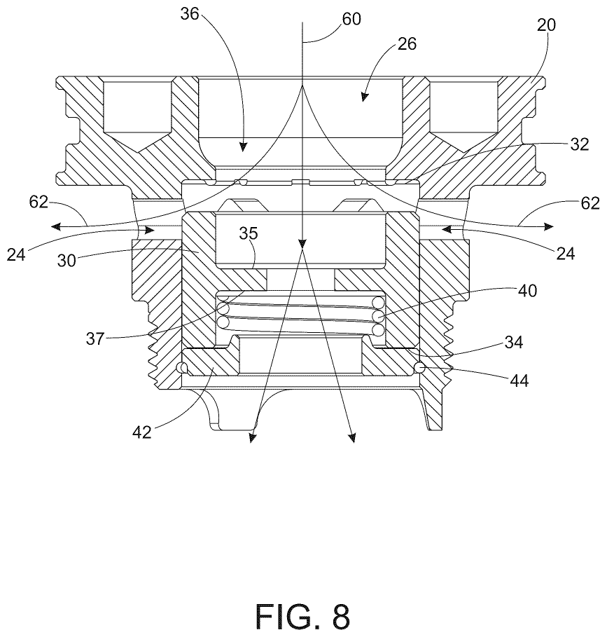

Operation of the valved bump stop 50 and the valve 10 are depicted in FIGS. 6-8. As a vehicle component, such as, but not limited to, a control arm of a vehicle contacts the bumper 54 of the bump stop 50, the piston rod 52 is moved further into the damper body 52. This results in the piston 20 of the valve 10 moving toward a top of the damper body 52, which is the end of the damper body opposite from where the piston rod 54 extends from the damper body 52. This movement of the piston 20 causes fluid to flow into the inlet 26 of the piston 20. As shown in FIG. 6, during low through mid-speeds of movement of the piston rod 54, the control orifice 36 allows fluid flow 60 to proceed through the control orifice and the spool 30 is maintained in the closed position covering the spool apertures 24 in the piston 20. In high speeds of movement of the piston rod 54, fluid flow 60 into the inlet 26 of the piston 20 is faster than the size of the control orifice 36 can allow, fluid engages fluid engagement surface 35 and increases the fluid pressure and therefore increases the force applied to the fluid engagement surface 35. When the force applied to the fluid engagement surface 35 exceeds the spring rate of the spring 40 the spool 30 moves toward outlet 27 of the piston 20 and toward an opened position as shown in FIG. 7, wherein a portion of the spool apertures 24 are exposed allowing additional flow area for blow off fluid flow 62 to flow through the spool apertures 24. The spool 30 continues to move until fully opened, as shown in FIG. 8 with the second end 34 of the spool 30 contacting the spring seat 42. The operation of the valve 10 reduces the damping force as high piston rod 54 speeds to be the same as or close to the desired mid-speed damping characteristics. The variable width of the spool apertures 24 allows more fluid to flow through as more of each of the spool apertures 24 are exposed. Once the fluid pressure and therefore the force applied to the fluid engagement surface 35 is less than the spring rate of the spring 40, the spring 40 applying force to the spring engagement surface 37 moves the spool from the opened position to the closed position.

Additionally, FIGS. 5-8 depict a method of using a valved bump stop 50. The method may comprise coupling a valved bump stop to a vehicle, the valved bump stop comprising: a damper body; a piston rod partially extending into the damper body; a bumper coupled to an end of the piston rod that extends out of the damper body; and a valve coupled to an end of the piston rod that extends into the damper body; contacting the bumper with a control arm of a vehicle during a high-speed compression cycle of a suspension of the vehicle; moving, at a high speed, the piston rod and the valve further into the damper body in response to the control arm contacting the bumper; initiating fluid flow into the valve and through a control orifice of the valve in response to moving the valve into the damper body; moving the valve from a closed position to an opened position in response to fluid pressure exceeding a predetermined level; opening additional fluid flow area in response to the valve moving to the opened position; and flowing fluid through the control orifice of the valve and the additional fluid flow area.

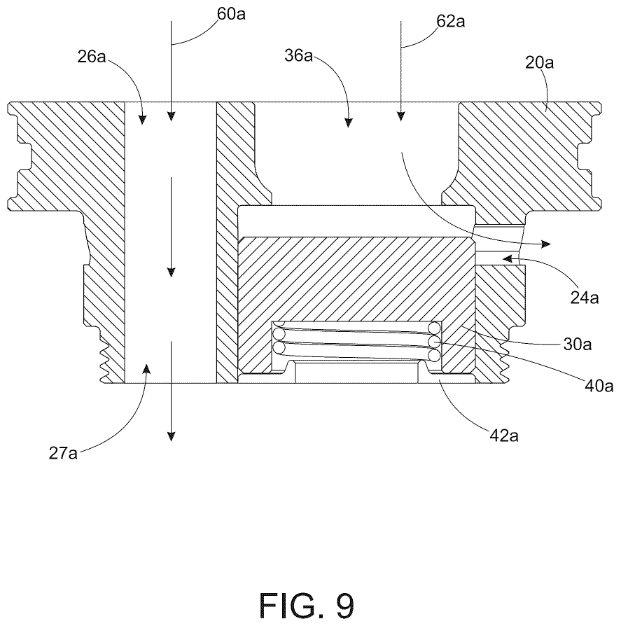

Additional embodiments are depicted in FIGS. 9-12. FIG. 9 shows a piston 20a having an inlet 26a and an outlet 27a. The piston 20a also includes a control inlet 36a that is parallel with the inlet 26a. The control inlet 36a extends into an inner volume retaining a spool 24a, a spring 40a and a spring seat 42a. During high-speed fluid flow that cannot be handled through the inlet 26a, fluid flow is directed to control inlet 36a until the force from the building fluid pressure exceeds the spring rate of the spring 40a and the spool 30a moves from the closed to the open position exposing one or more spool apertures 24a for blow off fluid flow 62a to flow through.

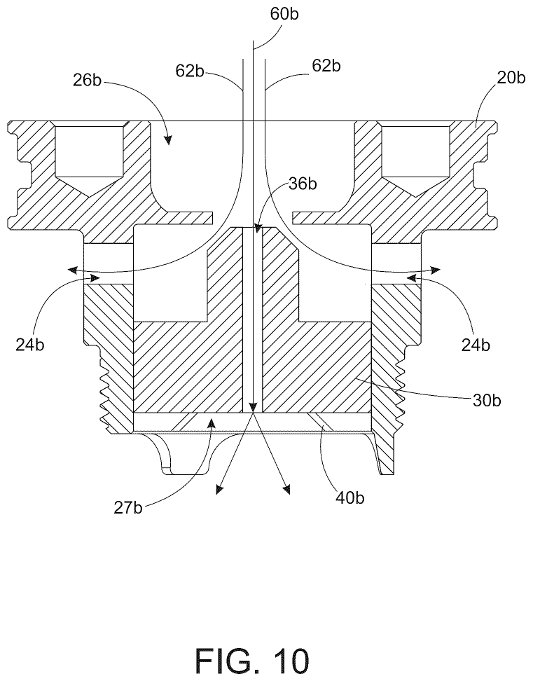

FIG. 10 shows a piston 20b having an inlet 26b and an outlet 27b. The piston 20b also includes an inner volume retaining a poppet valve 30b having a control orifice 36b and a spring 40b. During high-speed fluid flow that cannot be handled through the control orifice 36b, the force from the building fluid pressure exceeds the spring rate of the spring 40b and the poppet valve 30b moves from the closed to the open position exposing one or more spool apertures 24b for blow off fluid flow 62b to flow through.

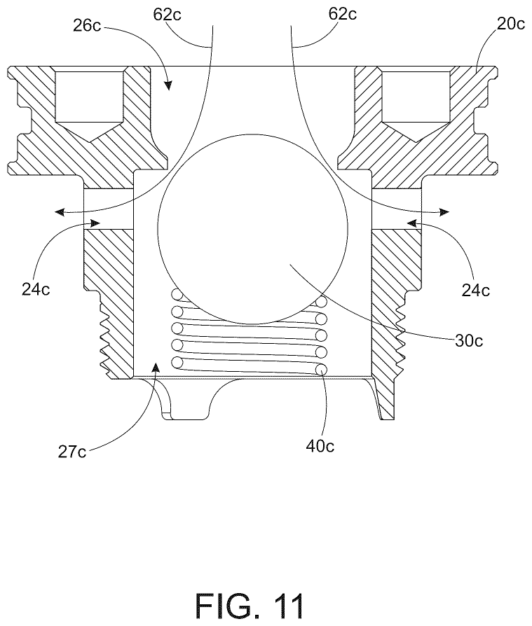

FIG. 11 shows a piston 20c having an inlet 26c and an outlet 27c. The piston 20c also includes an inner volume retaining a ball valve 30c and a spring 40c. During high-speed fluid flow, the force from the building fluid pressure exceeds the spring rate of the spring 40c and the ball valve 30c moves from the closed to the open position exposing one or more spool apertures 24c for blow off fluid flow 62c to flow through.

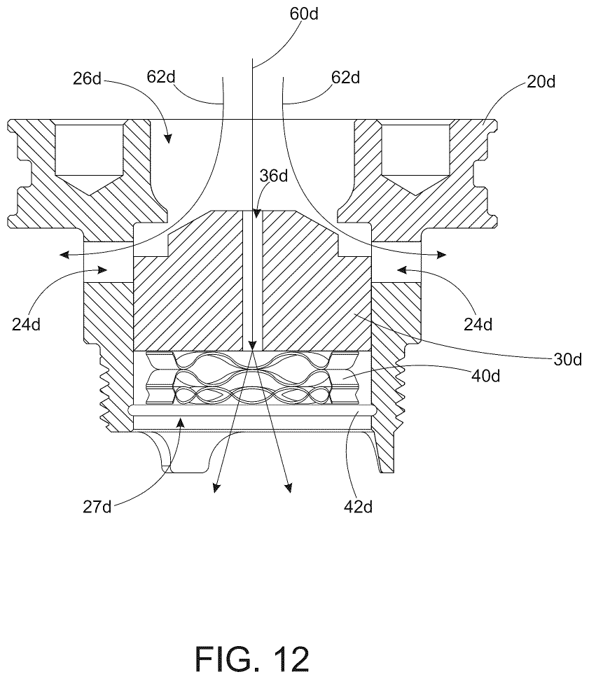

FIG. 12 shows a piston 20d having an inlet 26d and an outlet 27d. The piston 20d also includes an inner volume retaining a spool 30d having a control orifice 36d and a wave spring 40d retained in place by a spring seat 42d. During high-speed fluid flow that cannot be handled through the control orifice 36d, the force from the building fluid pressure exceeds the spring rate of the spring 40d and the spool 30d moves from the closed to the open position exposing one or more spool apertures 24d for blow off fluid flow 62d to flow through.

It will be understood that this could affect any hydraulic scenario where pressure drop through an orifice is creating damping force. This could be main pistons, base valves, adjusters, or other aspects. This could help alleviate frame fatigue issues or point loading issues with large force spikes at high rod velocities.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A valve for a bump stop, the valve comprising:
a piston comprising an inner volume, an inlet for fluid flow to enter the inner volume, and a plurality of spool apertures extending through a sidewall of the piston into the inner volume;
a spool comprising a first end, a second end, a fluid engagement surface facing the first end, a spring engagement surface facing the second end, and a control orifice providing fluid access from the first end to the second end, the spool coupled within the inner volume with the first end positioned toward the inlet of the piston, the spool moveable between a closed position and an opened position; and
a spring engaging the spring engagement surface of the spool, wherein:
the spring biases the spool to the closed position covering the plurality of spool apertures preventing fluid flow therethrough and only allowing fluid flow through the control orifice; and
the spool moves to the opened position by compressing the spring in response to fluid pressure applied to the fluid engagement surface of the spool exceeds a spring rate of the spring, wherein the opened position exposed at least a portion of each of the plurality of spool apertures allowing fluid flow through the plurality of spool apertures and the control orifice.

2. The valve of claim 1, wherein each spool aperture of the plurality of spool apertures comprises a variable width.

3. The valve of claim 2, wherein each spool aperture of the plurality of spool apertures is a triangular-like shape.

4. The valve of claim 1, further comprising a spring seat coupled within the inner volume, wherein the spring is coupled between the spring seat and the spool.

5. The valve of claim 4, wherein the spring seat location preloads the spring and biases the spring toward the closed position.

6. The valve of claim 1, wherein piston further comprises a lip within the inner volume, wherein the spool engages the lip when the spool is in the closed position.

7. A valved bump stop comprising:
a damper body;
a piston rod partially extending into the damper body;
a bumper coupled to an end of the piston rod that extends out of the damper body; and
a valve coupled to an end of the piston rod that extends into the damper body, wherein the valve comprises:
a piston comprising an inner volume, an inlet for fluid flow to enter the inner volume, and a plurality of spool apertures extending through a sidewall of the piston into the inner volume;
a spool comprising a first end, a second end, a fluid engagement surface facing the first end, a spring engagement surface facing the second end, and a control orifice providing fluid access from the first end to the second end, the spool coupled within the inner volume with the first end positioned toward the inlet of the piston, the spool moveable between a closed position and an opened position; and
a spring engaging the spring engagement surface of the spool, wherein:
the spring biases the spool to the closed position covering the plurality of spool apertures preventing fluid flow therethrough and only allowing fluid flow through the control orifice; and
the spool moves to the opened position by compressing the spring in response to fluid pressure applied to the fluid engagement surface of the spool exceeds a spring rate of the spring, wherein the opened position exposed at least a portion of each of the plurality of spool apertures allowing fluid flow through the plurality of spool apertures and the control orifice.

8. The valved bump stop of claim 7, wherein each spool aperture of the plurality of spool apertures comprises a variable width.

9. The valved bump stop of claim 8, wherein each spool aperture of the plurality of spool apertures is a triangular-like shape.

10. The valved bump stop of claim 7, further comprising a spring seat coupled within the inner volume, wherein the spring is coupled between the spring seat and the spool.

11. The valved bump stop of claim 10, wherein the spring seat location preloads the spring and biases the spring toward the closed position.

12. The valved bump stop of claim 7, wherein piston further comprises a lip within the inner volume, wherein the spool engages the lip when the spool is in the closed position.

13. A method of using a valved bump stop, the method comprising:
coupling a valved bump stop to a vehicle, the valved bump stop comprising:
a damper body;
a piston rod partially extending into the damper body;
a bumper coupled to an end of the piston rod that extends out of the damper body; and
a valve coupled to an end of the piston rod that extends into the damper body;
contacting the bumper with a control arm of a vehicle during a high-speed compression cycle of a suspension of the vehicle;
moving, at a high speed, the piston rod and the valve further into the damper body in response to the control arm contacting the bumper;
initiating fluid flow into the valve and through a control orifice of the valve in response to moving the valve into the damper body;
moving the valve from a closed position to an opened position in response to fluid pressure exceeding a predetermined level;
opening additional fluid flow area in response to the valve moving to the opened position; and
flowing fluid through the control orifice of the valve and the additional fluid flow area.

14. The method of claim 13, wherein the valve comprises:
a piston comprising an inner volume, an inlet for fluid flow to enter the inner volume, and a plurality of spool apertures extending through a sidewall of the piston into the inner volume;
a spool comprising a first end, a second end, a fluid engagement surface facing the first end, a spring engagement surface facing the second end, and the control orifice providing fluid access from the first end to the second end, the spool coupled within the inner volume with the first end positioned toward the inlet of the piston, the spool moveable between a closed position and an opened position; and
a spring engaging the spring engagement surface of the spool, wherein:
the spring biases the spool to the closed position covering the plurality of spool apertures preventing fluid flow therethrough and only allowing fluid flow through the control orifice; and
the spool moves to the opened position by compressing the spring in response to fluid pressure applied to the fluid engagement surface of the spool exceeds a spring rate of the spring, wherein the opened position exposed at least a portion of each of the plurality of spool apertures allowing fluid flow through the plurality of spool apertures and the control orifice.

15. The method of claim 14, wherein each spool aperture of the plurality of spool apertures comprises a variable width.

16. The method of claim 15, wherein each spool aperture of the plurality of spool apertures is a triangular-like shape.

17. The method of claim 14, further comprising a spring seat coupled within the inner volume, wherein the spring is coupled between the spring seat and the spool.

18. The method of claim 17, wherein the spring seat location preloads the spring and biases the spring toward the closed position.

19. The method of claim 14, wherein piston further comprises a lip within the inner volume, wherein the spool engages the lip when the spool is in the closed position.
